(19) United States
(12) Patent Application Publication
(10) Pub. No.: US 2019/0042797 A1
(43) Pub. Date: Feb. 7, 2019

(54) Security Hardware Access Management

(71) Applicant: INTEL CORPORATION, Santa Clara, CA (US)

(72) Inventors: Aditya Katragada, Austin, TX (US); Gregg Lahti, Gilbert, AZ (US); Peter Munguia, Chandler, AZ (US)

(73) Assignee: INTEL CORPORATION, Santa Clara, CA (US)

(21) Appl. No.: 15/856,130

(22) Filed: Dec. 28, 2017

(51) Int. Cl. G06F 21/71; G06F 21/60

(52) U.S. Cl. CPC G06F 21/71; H04L 9/0643; G06F 21/602

(57) ABSTRACT

In one example, a system for managing access to hardware components includes a processor to manage a transition of a component from a known trusted first state and a context of a first application to a known trusted second state and a context of a second application based on trusted meta-data. The processor can also prevent contamination across the known trusted state of each application based on the trusted meta-data associated with each application. Additionally, the processor can detect a change of a trust boundary from the first application to the second application, save the first state of the first application accessing the component, remove said first state from the component, initialize and load the second state of the second application accessing the component, and execute the second application via the component based on the second state.

### TECHNICAL FIELD

This disclosure relates generally to securely sharing hardware components, but not exclusively, to managing secure uses of said hardware components by agents.

### BACKGROUND

Computing devices can execute applications in trust environments with predefined boundaries (trusted compute boundaries, or TCBs) that prevent other applications from altering or entering said TCBs. In some examples, the trust environments prevent other applications from accessing unauthorized data, or altering a control flow within a TCB. In some examples, a hardware component in a computing device can enable multiple applications to mutually exclusive use within a trust environment.

### BRIEF DESCRIPTION OF THE DRAWINGS

The following detailed description may be better understood by referencing the accompanying drawings, which contain specific examples of numerous features of the disclosed subject matter.

FIG. 1 illustrates a block diagram of a computing device that can manage access to hardware security components;

FIG. 2 illustrates a process flow diagram for managing access to hardware security components;

FIG. 3 illustrates a block diagram of data flow in a system for managing access to hardware security components;

FIG. 4 illustrates a block diagram of managing access to hardware security components; and

FIG. 5 is an example of a tangible, non-transitory computer-readable medium for managing access to hardware security components.

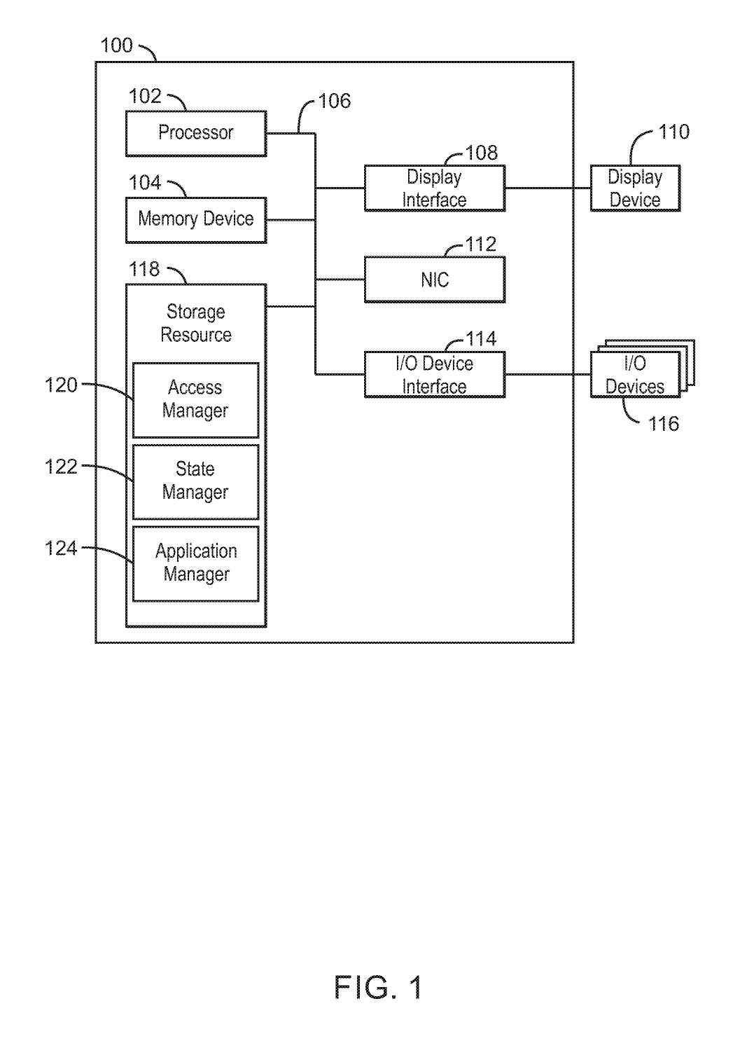

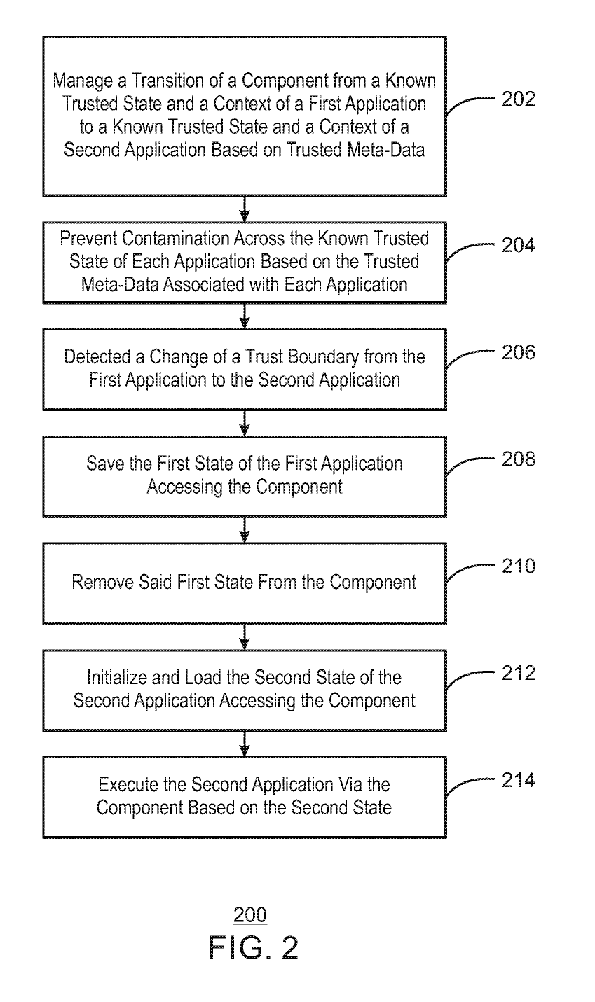

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Applications executed by a computing device can store data within trust boundaries that the applications can access. Unauthorized applications outside the trust boundary can attempt to access data or manipulate state data stored by authorized applications being executed. In some embodiments, each application is allowed access to state and data within its trust boundary. Accordingly, hardware components for managing an application's trust boundaries can be statically assigned to each application or time multiplexed. However, these techniques can result in multiple copies of hardware components or a single application that utilizes a security hardware component for an extended period of time while other applications attempting to utilize the security hardware component are unable to be executed.

The techniques described herein enable dynamic runtime switching of context based on trust states of agents utilizing a hardware resource. An agent, as referred to herein, can include any suitable application, operating system, and the like that has a different trust boundary. In some examples, agents can be secured or unsecured. In some embodiments, the techniques include using a combination of techniques based on meta-data such as rights management control bits, address bits, cycle types, TCB descriptors, source or destination IDs, security attributes, etc. or similar hardware enforced security context. The technique enables hardware logic to dynamically save and restore hardware context based on an initiating agent, which results in the processor switching context and trust states between trust domains of each application.

In some embodiments, a processor can manage a transition of a component from a known trusted state and a context of a first application to a known trusted state and a context of a second application based on trusted meta-data. The processor can also prevent contamination across the known trusted state of each application based on the trusted meta-data associated with each application. Additionally, the processor can detect a change of a trust boundary from the first application to the second application, save the first state of the first application accessing the component, and remove said first state from the component. Furthermore, the processor can initialize and load the second state of the second application accessing the component. In addition, the processor can execute the second application via the component based on the second state.

In some embodiments, the techniques enable system on chip devices to share a hardware resource for accessing secured data between multiple agents with different trust boundaries. For example, the techniques enable multiple applications with different trust boundaries to share a hardware resource that implements biometric access, video analytics, security and content protection, among others.

Reference in the specification to “one embodiment” or “an embodiment” of the disclosed subject matter means that a particular feature, structure, or characteristic described in connection with the embodiment is included in at least one embodiment of the disclosed subject matter. Thus, the phrase “in one embodiment” may appear in various places throughout the specification, but the phrase may not necessarily refer to the same embodiment.

FIG. 1 is a block diagram of an example of a host computing device that can manage access to hardware security components. The host computing device 100 may be, for example, a mobile phone, laptop computer, desktop computer, or tablet computer, among others. The host computing device 100 may include a processor 102 that is adapted to execute stored instructions, as well as a memory device 104 that stores instructions that are executable by the processor 102 (also referred to herein as an application processor). The processor 102 can be a single core processor, a multi-core processor, a computing cluster, or any number of other configurations. The memory device 104 can include random access memory, read only memory, or any other suitable memory systems. The instructions that are executed by the processor 102 may be used to implement a method that can manage access to hardware security components.

The processor 102 may also be linked through the system interconnect 106 (e.g., PCI®, PCI-Express®, NuBus, etc.) to a display interface 108 adapted to connect the host computing device 100 to a display device 110. The display device 110 may include a display screen that is a built-in component of the host computing device 100. The display device 110 may also include a computer monitor, television, or projector, among others, that is externally connected to the host computing device 100. The display device 110 can include light emitting diodes (LEDs), and micro-LEDs, among others.

In addition, a network interface controller (also referred to herein as a NIC) 112 may be adapted to connect the host computing device 100 through the system interconnect 106 to a network (not depicted). The network (not depicted) may be a cellular network, a radio network, a wide area network (WAN), a local area network (LAN), or the Internet, among others.

The processor 102 may be connected through a system interconnect 106 to an input/output (I/O) device interface 114 adapted to connect the computing host device 100 to one or more I/O devices 116. The I/O devices 116 may include, for example, a keyboard and a pointing device, wherein the pointing device may include a touchpad or a touchscreen, among others. The I/O devices 116 may be built-in components of the host computing device 100, or may be devices that are externally connected to the host computing device 100.

In some embodiments, the processor 102 may also be linked through the system interconnect 106 to any security or hardware resource 118 that can include a hard drive, an optical drive, a USB flash drive, an array of drives, or any combinations thereof. In some embodiments, the security or hardware resource 118 can include any suitable applications. In some embodiments, the security or hardware resource 118 can include an access manager 120, a state manager 122, and an application manager 124. In some embodiments, the access manager 120 can manage a transition of a component from a known trusted state and a context of a first application to a known trusted state and a context of a second application based on trusted meta-data. The access manager 120 can also prevent contamination across the known trusted state of each application based on the trusted meta-data associated with each application. In some embodiments, the state manager 122 can detect a change of a trust boundary from the first application to the second application and save the first state of the first application accessing the component. The state manager 122 can also remove said first state from the component and initialize and load the second state of the second application accessing the component. Furthermore, the application manager 124 can execute the second application via the component based on the second state.

It is to be understood that the block diagram of FIG. 1 is not intended to indicate that the host computing device 100 is to include all of the components shown in FIG. 1. Rather, the host computing device 100 can include fewer or additional components not illustrated in FIG. 1 (e.g., additional memory components, embedded controllers, additional modules, additional network interfaces, memory controllers, etc.). Furthermore, any of the functionalities of the access manager 120, state manager 122, and application manager 124 may be partially, or entirely, implemented in hardware and/or in the processor 102. For example, the functionality may be implemented with an application specific integrated circuit, logic implemented in an embedded controller, or in logic implemented in the processor 102, among others. In some embodiments, the functionalities of the access manager 120, state manager 122, and application manager 124 can be implemented with logic, wherein the logic, as referred to herein, can include any suitable hardware (e.g., a processor, among others), software (e.g., an application, among others), firmware, or any suitable combination of hardware, software, and firmware.

FIG. 2 illustrates a process flow diagram for managing access to a hardware security component. The method 200 illustrated in FIG. 2 can be implemented with any suitable computing component or device, such as the computing device 100 of FIG. 1.

At block 202, an access manager 120 can manage a transition of a component from a known trusted first state and a context of a first application to a known trusted second state and a context of a second application based on trusted meta-data. In some embodiments, the access manager 120 can detect a transition from an unsecured application to a secured application or from a secured application to an unsecured application. In some examples, each application can be associated with a different trust boundary. For example, the first application can access a first set of memory address and the second application can access a second set of memory addresses, wherein the first set of memory addresses and the second set of memory addresses are mutually exclusive from a system's point of view, but map to the same shared resource or component.

In some examples, the shared resource or security component can include any logic or hardware device residing on a system on a chip, on a processor, or in a computing device, wherein the security component can manage access to secured data and non-secured data. For example, the security component can manage access to secured keys associated with any number of applications, secure data for the corresponding applications, non-secured data, and the like. In one example, a cryptography engine or encryption engine can be shared between multiple agents. For example, a shared component such as an encryption engine can be shared by a video player for protected content as well as by an operating system for disk encryption of a flash device. In another example, a storage controller can be shared by two different processors running different trust level software to fetch data from a flash device into system memory. Each processor can fetch its code and can prevent the other processor from modifying or reading data.

At block 204, the access manager 120 can prevent contamination across the known trusted state of each application based on the trusted meta-data associated with each application. In some examples, the trusted meta-data is hardware enforced or software enforced. In some embodiments, the trusted meta-data defines a plurality of trusted states and rights management associated with each application.

At block 206, a state manager 122 can detect a change of a trust boundary from the first application to the second application. For example, the state manager 122 can detect that a second application with a second trust boundary is attempting to access a shared resource providing data to a first application with a first trust boundary.

At block 208, the state manager 122 can save a first state of the first application accessing the component. In some examples, the first state can include at least one secure key associated with the first application and secured data corresponding to the first application. In some examples, the first state can also include intermediate keys for cryptography. In some embodiments, the first state for DMA engines can include a current element of a link list being processed. In some embodiments, the first state can include a register state indicating a source and a destination of DMA data. In a system with two processors, in one example, each processor can copy data from a flash memory address that is the intermediate data during dynamic switching.

At block 210, the state manager 122 can remove said first state from the component. For example, the state manager 122 can delete data associated with the first state.

At block 212, the state manager 122 can initialize and load a second state of the second application accessing the security component. In some examples, the second state can include at least one secure key associated with the second application and non-secured data corresponding to the second application. The second state can also include intermediate keys for cryptography, a current element of a link list being processed by a DMA engine, a register state indicating a source and a destination of DMA data, and the like. The second state can represent context data previously saved, which is to be restored for an agent.

At block 214, an application manager 124 can execute an instruction for the second application via the security component based on the second state. For example, the application manager 124 can enable the second application to access data within a trust boundary or memory address range assigned to the second application.

The process flow diagram of FIG. 2 is not intended to indicate that the operations of the method 200 are to be executed in any particular order, or that all of the operations of the method 200 are to be included in every case. Additionally, the method 200 can include any suitable number of additional operations. In some examples, the security component comprises a multiplexor that transitions accessing the at least one secure key associated with the first application to the at least one secure key associated with the second application. In some examples, the security component comprises logic to calculate an intermediate SHA2 value to be stored with the first state of the first application. In some examples, the security component comprises logic to calculate a direct memory access value to be stored with the first state of the first application. In some embodiments, the access manager 120 can access a secure register for the first application and a non-secure register for the second application via the security component. In some examples, the method 200 can include detecting a transition from a first trust boundary of the first application to a second trust boundary of the second application and detecting a transition from the second trust boundary of the second application to the first trust boundary of the first application. In some embodiments, the access manager 120 can access a register deemed secure for the first application and the same register deemed non-secure for the second application or the access manager 120 can access a register deemed non-secure for the first application and the same register deemed secure for the second application via the security component.

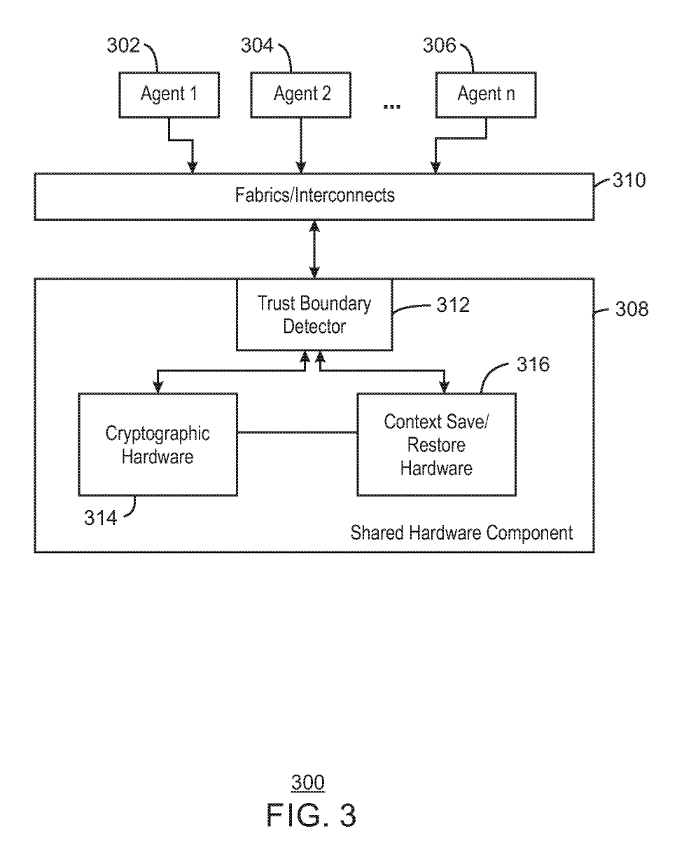

FIG. 3 illustrates a block diagram of a system for managing access to a hardware security component. The system 300 can be any suitable computing device, such as computing device 100 of FIG. 1.

In some embodiments, the system 300 can include any suitable number of agents, such as agent 1 302, and agent 2 304, through agent N 306. Each of the agents 302, 304, and 306 can access a shared hardware component 308 via fabrics/interconnects 310. The fabrics/interconnects 310 can include PCI®, PCI-Express®, NuBus, and the like. In some examples, agent 1 302, agent 2 304, and agent N 306 can include any suitable application or operating system. In some embodiments, agent 1 302, agent 2 304, and agent N 306 can have different trust boundaries or accessible memory address ranges. In some examples, agent 1 302, agent 2 304, and agent N 306 can each dynamically access the shared hardware component 308 at runtime.

In some embodiments, the shared hardware component 308 can include a trust boundary detector 312, cryptographic hardware 314, and context save/restore hardware 316. In some examples, the trust boundary detector 312 can identify the calling agent. For example, the trust boundary detector 312 can identify a unique identifier associated with an agent or application accessing the shared hardware component 308. In some examples, the context save/restore hardware 316 detects input from the trust boundary detector 312 to switch contexts of a local state of the cryptographic hardware 314 based on the calling agent. For example, when agent 1 302 sends a set of commands and control information to the cryptographic hardware 314, the change in trust boundary can be detected from the set of commands and the cryptographic hardware 314 can be initialized based on a previous state of agent 1 302. The set of commands can include any suitable transaction, request, or instruction. In some embodiments, the change in trust boundary can be detected inline by detecting a request in progress rather than stalling a pipeline to detect the request. When agent 2 304 sends a set of commands to the cryptographic hardware 314, the state of agent 1 302 can be saved securely and a state of the requesting agent 2 304 can be loaded and restored. Accordingly, the cryptographic hardware 314 can be dynamically shared in a secure manner based on a requesting agent. In some embodiments, the final results of a cryptographic operation for a requesting agent can be reflected in access controlled registers for the requesting agent.

It is to be understood that the block diagram of FIG. 3 is not intended to indicate that the system 300 is to include all of the components shown in FIG. 3. Rather, the system 300 can include fewer or additional components not illustrated in FIG. 3 (e.g., additional memory components, embedded controllers, additional sensors, additional interfaces, etc.). In some embodiments, when the number of trust boundaries increase from two boundaries (trusted and untrusted) to a higher number of trust boundaries, the techniques herein provide a linearly scalable model. For example, a system with three CPUs may assign each CPU to a separate function such as image capturing, video processing, or any other suitable type of processing. In one example, the system may include a fourth CPU executed in a trusted execution environment. Accordingly, each of the four CPUs can have different trust boundaries and can share the same shared hardware component 308 or cryptographic resource.

In some embodiments, the techniques described herein can efficiently share cryptographic engines between multiple agents such as one or more virtualized domains supporting an operating system, or a real time subsystem and a trusted environment (TEE). In some examples, the techniques can share cryptographic engines without duplicating the hardware for the cryptographic engine or generating a lag in time switching the hardware resource. For example, if there is a secure digital rights management (DRM) flow that is executing in a TEE that includes high resolution content, the DRM flow may be very bandwidth intensive. If the same cryptographic hardware is accessed by operating system software to perform disk decryption, the techniques described herein can reduce costly latencies and enforce trust boundaries while using software to switch the cryptographic hardware back and forth from a trusted side (TEE) to an untrusted side (operating system), which can improve a user experience and increase throughput.

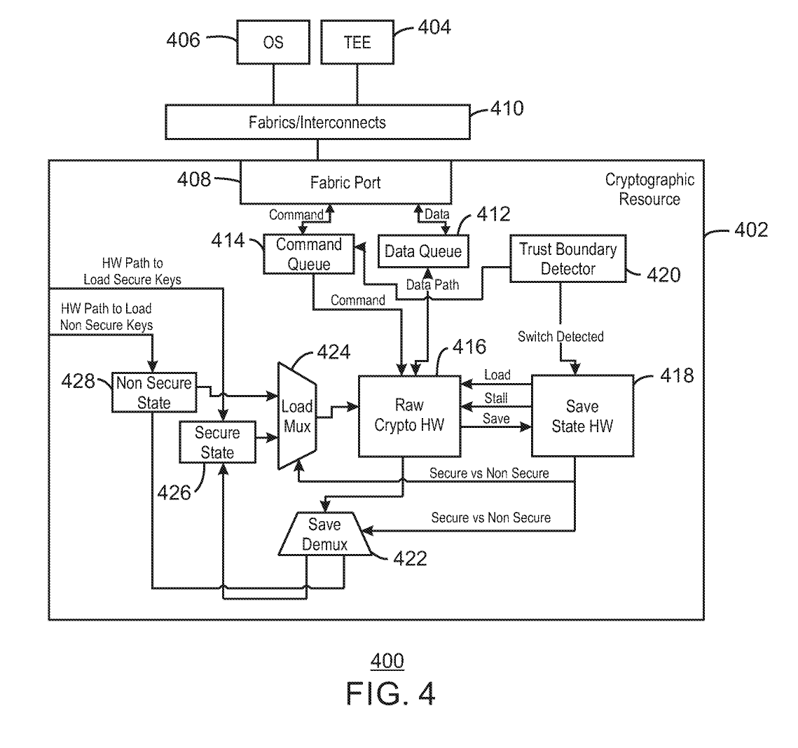

FIG. 4 illustrates a block diagram of managing dynamic access to a hardware security component. In some embodiments, the system 400 enables a cryptographic resource 402 to be dynamically shared among any number of agents such as a trusted execution environment (TEE) 404 and an operating system 406. In some examples, a trust boundary indication for the trusted TEE 404 and the operating system 406 is detected via security attributes of initiator (SAIs). The SAIs can be any suitable unique identifier in an on-chip system fabric that can identify an initiator. In some examples, the cryptographic resource 402 implements any suitable encryption algorithm such as SHA2, and/or direct memory access (DMA), among others.

In some examples, the system 400 can use a fabric port 408 to detect data from the TEE 404 or the operating system 406 via the fabrics/interconnects 410. In some examples, the fabric port 408 can arbitrate or manage access requests from the fabrics/interconnects 410 and transmit responses to any suitable agent.

In some examples, the fabric port 408 can transmit data to a data queue 412 and a command queue 414. In some examples, the data queue 412 and the command queue 414 can store incoming requests such as bus signals e.g. the SAI or AxPROT bits identifying the agent from which the requests originated. In some embodiments, the AxPROT bits can also indicate a protection level of a request such as if a request for data is normal or privileged, secure or non-secure, and whether the request is a data access or an instruction access. In some embodiments, the data queue 412 and the command queue 414 can transmit a request from an agent, such as the TEE 404 or the operating system 406, to raw cryptographic hardware 416. In some embodiments, the raw cryptographic hardware 416 can be an algorithm or hardware resource that is shared dynamically between multiple trusted and untrusted agents. The raw cryptographic hardware 416 can support indications from a save state hardware block 418 to either stall or continue executing a request. In some embodiments, the raw cryptographic hardware 416 can also support a mechanism to save and restore context such as keys or intermediate buffers. The raw cryptographic hardware 416 may support cryptographic operations based on SHA2 or any other suitable encryption technique.

In some embodiments, a trust boundary detector 420 can detect the SAIs of each agent's request in the command queue 414 and monitor for requests corresponding to trust boundary switching from a trusted agent to an untrusted agent (like from the OS to TEE or vice versa) or vice versa in consecutive agent requests in the command queue 414. In some embodiments, the trust boundary detector 420 can transmit a signal to save state hardware 418 in response to detecting consecutive agent requests in the command queue 414 that transition from a trusted agent to an untrusted agent (like from the TEE to the OS or vice versa) or from an untrusted agent to a trusted agent.

In some embodiments, the save state hardware 418 can detect if a switch between a trusted agent and an untrusted agent (like OS and TEE) has occurred based on the signal from the trust boundary detector 420. In some examples, the save state hardware 418 can schedule a save of the cryptographic state, which can include encryption keys and intermediate cryptographic buffers, among others. In some examples, the saved data associated with the cryptographic state can be cryptographic specific or specific to the cryptographic resource 402. In some examples, the save state hardware can transmit a signal to the raw cryptographic hardware 416 to either stall execution of operations for an agent or continue execution of operations for an agent. Stalling execution of operations for an agent can prevent cryptographic operations from continuing during a save operation to prevent data corruption or integrity violation. In some embodiments, the raw cryptographic hardware 416 can continue if there is no change in current state from the trust boundary detector 420.

In some embodiments, the save state hardware 418 can stall the raw cryptographic hardware 416 and switch a save de-multiplexor 422 to offload the current context of an agent that is executing operations with the cryptographic resource 402. In some embodiments, the save state hardware 418 can also trigger a current state of the agent executing operations with the cryptographic resource 402. In some embodiments, the save state hardware 418 can also modify a load multiplexor 426 to load new context information corresponding to a requesting agent. In some embodiments, the save state hardware 418 can also load a state of the requesting agent and allow a cryptographic operation for the requesting agent to continue.

In some embodiments, the load multiplexor 424 can direct access to a secure state 426 corresponding to secure keys or data saved from either the secure registers or RAM or an unsecured state 428 corresponding to data stored in non-secure registers or RAM based on a select signal from the save state hardware 418. In some embodiments, the save de-multiplexer 422 can direct access to a current cryptographic state from raw cryptographic hardware 416 to either secure or non-secure registers/RAM.

In some embodiments, the secure registers or RAM correspond to the secure state 426 and can store encryption keys or intermediate data that is within the secure trust boundary of an agent. In some examples, the secure state 426 can include data loaded into secure registers or RAM from fuses, provisioned keys, and the like. In some examples, the secure state 426 is protected (or exposed) based on SAIs of incoming requests from agents. In some examples, the secure registers or RAM corresponding to the secure state 426 can be cleared and initialized each time an agent with a different trust boundary is accessing the secure registers or RAM.

In some embodiments, the non-secure registers or RAM correspond to the non-secure state 428 and can store encryption keys or intermediate data that is within the non-secure trust boundary of an agent. In some examples, the non-secure state 428 can include data loaded into non-secure registers or RAM from fuses, provisioned keys, and the like.

It is to be understood that the block diagram of FIG. 4 is not intended to indicate that the system 400 is to include all of the components shown in FIG. 4. Rather, the system 400 can include fewer or additional components not illustrated in FIG. 4 (e.g., additional memory components, embedded controllers, additional sensors, additional interfaces, etc.).

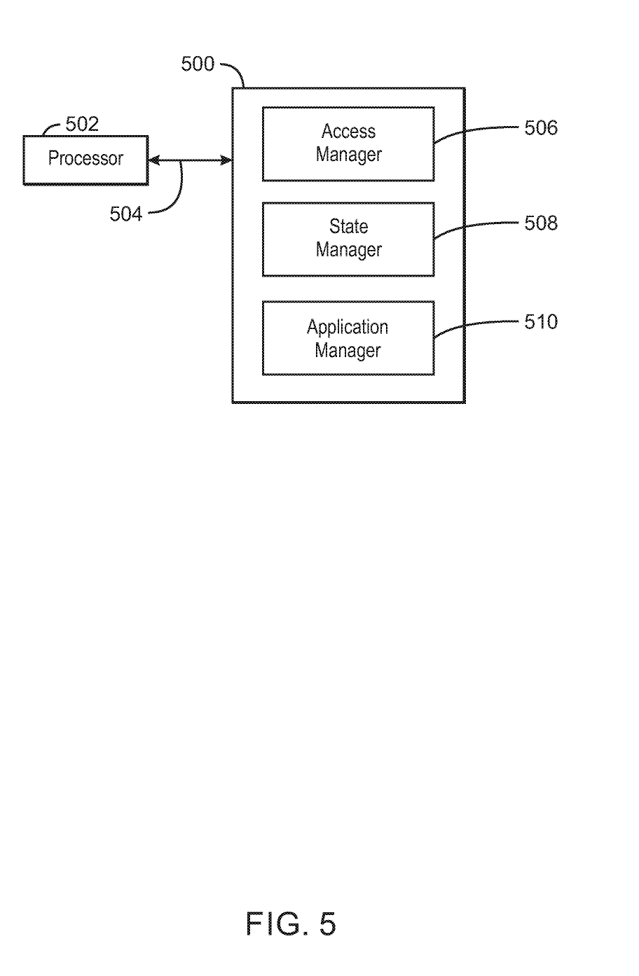

FIG. 5 illustrates a block diagram of a non-transitory computer readable media for managing access to a hardware security component. The tangible, non-transitory, computer-readable medium 500 may be accessed by a processor 502 over a computer interconnect 504. Furthermore, the tangible, non-transitory, computer-readable medium 500 may include code to direct the processor 502 to perform the operations of the current method.

The various software components discussed herein may be stored on the tangible, non-transitory, computer-readable medium 500, as indicated in FIG. 5. For example, an access manager 506 can manage a transition of a component from a known trusted state and a context of a first application to a known trusted state and a context of a second application based on trusted meta-data. The access manager 506 can also prevent contamination across the known trusted state of each application based on the trusted meta-data associated with each application. In some embodiments, a state manager 508 can detect a change of a trust boundary from the first application to the second application and save the first state of the first application accessing the component. The state manager 508 can also remove said first state from the component and initialize and load the second state of the second application accessing the component. Furthermore, an application manager 510 can execute the second application via the component based on the second state.

It is to be understood that any suitable number of the software components shown in FIG. 5 may be included within the tangible, non-transitory computer-readable medium 500. Furthermore, any number of additional software components not shown in FIG. 5 may be included within the tangible, non-transitory, computer-readable medium 500, depending on the specific application.

### EXAMPLES

### Example 1

In one example, a system for managing access to hardware components can include a processor to manage a transition of a component from a known trusted first state and a context of a first application to a known trusted second state and a context of a second application based on trusted meta-data. The processor can also prevent contamination across the known trusted state of each application based on the trusted meta-data associated with each application. Additionally, the processor can detect a change of a trust boundary from the first application to the second application, and save the first state of the first application accessing the component. Furthermore, the processor can remove said first state from the component and initialize and load the second state of the second application accessing the component. Moreover, the processor can execute the second application via the component based on the second state.

Alternatively, or in addition, the first state comprises at least one secure key associated with the first application and secured data corresponding to the first application. Alternatively, or in addition, the second state comprises at least one secure key associated with the second application and non-secured data corresponding to the second application. Alternatively, or in addition, the component comprises a multiplexor that transitions accessing the at least one secure key or the secured data associated with the first application to the at least one secure key or the non-secured data associated with the second application. Alternatively, or in addition, the component comprises logic to calculate an intermediate SHA2 value to be stored with the first state of the first application. Alternatively, or in addition, the processor is to access a register deemed secure for the first application and the same register deemed non-secure for the second application via the security component or the processor is to access a register deemed non-secure for the first application and the same register deemed secure for the second application via the security component. Alternatively, or in addition, the processor is to detect a transition from a first trust boundary of the first application to a second trust boundary of the second application and detect a transition from the second trust boundary of the second application to the first trust boundary of the first application. Alternatively, or in addition, the trusted meta-data is hardware enforced or software enforced. Alternatively, or in addition, the trusted meta-data defines a plurality of trusted states and rights management associated with each application.

### Example 2

In one example, a method for managing access to hardware components with a secure technique can include managing a transition of a component from a known trusted first state and a context of a first application to a known trusted second state and a context of a second application based on trusted meta-data wherein the trusted meta-data is hardware enforced or software enforced. The method can also include preventing contamination across the known trusted states of each application based on the trusted meta-data associated with each application wherein the trusted meta-data defines a plurality of trusted states and rights management associated with each application. Additionally, the method can include detecting a change of trust boundary from the first application to the second application, saving the first state of the first application accessing the component, and removing said first state from the component. Furthermore, the method can include initializing and load the second state of the second application accessing the component. Moreover, the method can include executing the second application via the component based on the second state.

Alternatively, or in addition, the first state comprises at least one secure key associated with the first application and secured data corresponding to the first application. Alternatively, or in addition, the second state comprises at least one secure key associated with the second application and secured data corresponding to the second application. Alternatively, or in addition, the component comprises a multiplexor that transitions accessing the at least one secure key associated with the first application to the at least one secure key associated with the second application. Alternatively, or in addition, the method includes calculating an intermediate SHA2 value to be stored with the first state of the first application. Alternatively, or in addition, the method includes accessing a register deemed secure for the first application and the same register deemed non-secure for the second application via the security component. Alternatively, or in addition, the method includes detecting a transition from a first trust boundary of the first application to a second trust boundary of the second application.

### Example 3

In one example, a non-transitory computer readable media for managing access to hardware components can include a plurality of instructions that, in response to execution by a processor, cause the processor to manage a transition of a component from a known trusted first state and a context of a first application to a known trusted second state and a context of a second application based on trusted meta-data wherein the trusted meta-data is hardware enforced or software enforced. The plurality of instructions can also cause the processor to prevent contamination across the known trusted states of each application based on the trusted meta-data associated with each application wherein the trusted meta-data defines a plurality of trusted states and rights management associated with each application. Additionally, the plurality of instructions can cause the processor to detect a change of trust boundary from the first application to the second application, save the first state of the first application accessing the component, remove said first state from the component, and initialize and load the second state of the second application accessing the component. Moreover, the plurality of instructions can cause the processor to execute the second application via the component based on the second state.

Alternatively, or in addition, the first state comprises at least one secure key associated with the first application and secured data corresponding to the first application. Alternatively, or in addition, the second state comprises at least one secure key associated with the second application and secured data corresponding to the second application. Alternatively, or in addition, the component comprises a multiplexor that transitions accessing the at least one secure key associated with the first application to the at least one secure key associated with the second application. Alternatively, or in addition, the plurality of instructions cause the processor to calculate a direct memory access value to be stored with the first state of the first application. Alternatively, or in addition, the plurality of instructions cause the processor to access a register deemed secure for the first application and the same register deemed non-secure for the second application via the security component.

Although an example embodiment of the disclosed subject matter is described with reference to block and flow diagrams in FIGS. 1-5, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A system for managing access to hardware components comprising:
a processor to:
manage a transition of a component from a known trusted first state and a context of a first application to a known trusted second state and a context of a second application based on trusted meta-data;
prevent contamination across the known trusted state of each application based on the trusted meta-data associated with each application;
detect a change of a trust boundary from the first application to the second application;
save the first state of the first application accessing the component;
remove said first state from the component;
initialize and load the second state of the second application accessing the component; and
execute the second application via the component based on the second state.

2. The system of claim 1, wherein the first state comprises at least one secure key associated with the first application and secured data corresponding to the first application.

3. The system of claim 2, wherein the second state comprises at least one secure key associated with the second application and non-secured data corresponding to the second application.

4. The system of claim 3, wherein the component comprises a multiplexor that transitions accessing the at least one secure key or the secured data associated with the first application to the at least one secure key or the non-secured data associated with the second application.

5. The system of claim 1, wherein the component comprises logic to calculate an intermediate SHA2 value to be stored with the first state of the first application.

6. The system of claim 1, wherein the processor is to access a register deemed secure for the first application and the same register deemed non-secure for the second application via the security component or the processor is to access a register deemed non-secure for the first application and the same register deemed secure for the second application via the security component.

7. The system of claim 1, wherein the processor is to detect a transition from a first trust boundary of the first application to a second trust boundary of the second application and detect a transition from the second trust boundary of the second application to the first trust boundary of the first application.

8. The system of claim 1, wherein the trusted meta-data is hardware enforced or software enforced.

9. The system of claim 1, wherein the trusted meta-data defines a plurality of trusted states and rights management associated with each application.

10. A method for managing access to hardware components with a secure technique comprising:
managing a transition of a component from a known trusted first state and a context of a first application to a known trusted second state and a context of a second application based on trusted meta-data, wherein the trusted meta-data is hardware enforced or software enforced;
preventing contamination across the known trusted states of each application based on the trusted meta-data associated with each application, wherein the trusted meta-data defines a plurality of trusted states and rights management associated with each application;
detecting a change of trust boundary from the first application to the second application;
saving the first state of the first application accessing the component;
removing said first state from the component;
initializing and loading the second state of the second application accessing the component; and
executing the second application via the component based on the second state.

11. The method of claim 10, wherein the first state comprises at least one secure key associated with the first application and secured data corresponding to the first application.

12. The method of claim 11, wherein the second state comprises at least one secure key associated with the second application and secured data corresponding to the second application.

13. The method of claim 12, wherein the component comprises a multiplexor that transitions accessing the at least one secure key associated with the first application to the at least one secure key associated with the second application.

14. The method of claim 10, comprising calculating an intermediate SHA2 value to be stored with the first state of the first application.

15. The method of claim 10, comprising accessing a register deemed secure for the first application and the same register deemed non-secure for the second application via the security component.

16. The method of claim 10, comprising detecting a transition from a first trust boundary of the first application to a second trust boundary of the second application.

17. A non-transitory computer readable media for managing access to hardware components comprising a plurality of instructions that, in response to execution by a processor, cause the processor to:
manage a transition of a component from a known trusted first state and a context of a first application to a known trusted second state and a context of a second application based on trusted meta-data wherein the trusted meta-data is hardware enforced or software enforced;
prevent contamination across the known trusted states of each application based on the trusted meta-data associated with each application wherein the trusted meta-data defines a plurality of trusted states and rights management associated with each application;
detect a change of trust boundary from the first application to the second application;
save the first state of the first application accessing the component;
remove said first state from the component;
initialize and load the second state of the second application accessing the component; and
execute the second application via the component based on the second state.

18. The non-transitory computer readable media of claim 17, wherein the first state comprises at least one secure key associated with the first application and secured data corresponding to the first application.

19. The non-transitory computer readable media of claim 18, wherein the second state comprises at least one secure key associated with the second application and secured data corresponding to the second application.

20. The non-transitory computer readable media of claim 19, wherein the component comprises a multiplexor that transitions accessing the at least one secure key associated with the first application to the at least one secure key associated with the second application.

21. The non-transitory computer readable media of claim 17, wherein the plurality of instructions cause the processor to calculate a direct memory access value to be stored with the first state of the first application.

22. The non-transitory computer readable media of claim 17, wherein the plurality of instructions cause the processor to access a register deemed secure for the first application and the same register deemed non-secure for the second application via the security component.
